(19) United States
(12) Patent Application Publication
(10) Pub. No.: US 2014/0211353 A1
(43) Pub. Date: Jul. 31, 2014

(54) PROTECTION CIRCUIT FOR FAN CONTROL CHIP

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: CHAO-RONG LAI, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/146,016

(22) Filed: Jan. 2, 2014

(30) Foreign Application Priority Data
Jan. 28, 2013 (CN) 2013100308499

(51) Int. Cl. H02H 9/04

(52) U.S. Cl. CPC H02H 9/044
USPC 361/91.5

(57) ABSTRACT

A protection circuit is connected between a fan control chip and a fan connector. The protection circuit includes a first resistor and a diode. A detecting pin of the fan control chip is connected to the anode of the diode. The cathode of the diode is connected to a detecting pin of the fan connector. The anode of the diode is also connected to a first power source through the first resistor.

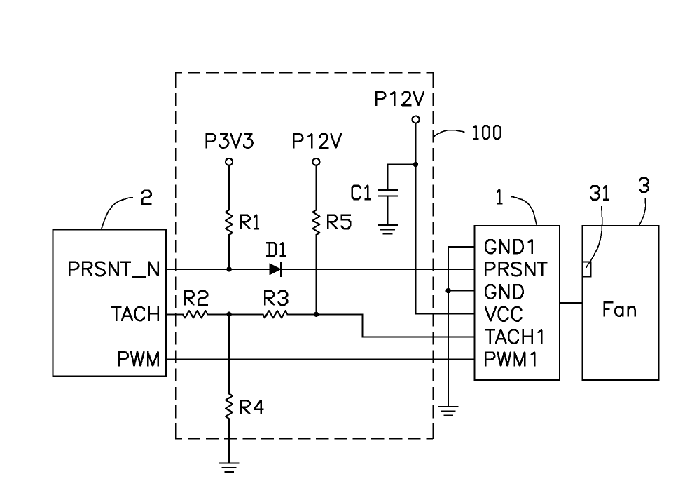

### BACKGROUND

1. Technical Field

The present disclosure relates to a protection circuit for a fan control chip.

2. Description of Related Art

In general, electronic devices, such as servers or personal computers, need to be repaired when the electronic devices cannot operate normally. An over-voltage may be generated when fans are unplugged from or plugged into the electronic device during repair, causing the fan control chip to be damaged. Therefore, there is room for improvement in the art.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the present embodiments.

The FIGURE is a circuit diagram of a protection circuit for a fan control chip in accordance with an embodiment.

### DETAILED DESCRIPTION

The disclosure, including the drawing, is illustrated by way of example and not by way of limitation. References to “an” or “one” embodiment in this disclosure are not necessarily to the same embodiment, and such references mean “at least one.”

The FIGURE shows a protection circuit 100 in accordance with an embodiment. The protection circuit 100 is connected between a fan connector 1 and a fan control chip 2, to prevent the fan control chip 2 from being damaged when the fan connector 1 is connected to or disconnected from a fan 3.

The protection circuit 100 comprises resistors R1-R5, a diode D1, and a capacitor C1. A detecting pin PRSNT_N of the fan control chip 2 is connected to an anode of the diode D1. A cathode of the diode D1 is connected to a detecting pin PRSNT of the fan connector 1.

The anode of the diode D1 is also connected to a power source P3V3 through the resistor R1. A speed pin TACH of the fan control chip 2 is connected to a speed pin TACH1 of the fan connector 1 through the resistors R2 and R3 in that order. A node between the resistors R2 and R3 is grounded through the resistor R4. The speed pin TACH1 of the fan connector 1 is connected to a power source P12V through the resistor R5. A signal pin PWM of the fan control chip 2 is connected to a signal pin PWM1 of the fan connector 1. Ground pins GND and GND1 of the fan connector 1 are grounded. A voltage pin VCC of the fan connector 1 is connected to the power source P12V. The capacitor C1 is connected between the voltage pin VCC of the fan connector 1 and ground. A voltage outputted from the power source P3V3 is 3.3 volts, and a voltage outputted from the power source P12V is 12 volts.

When the fan connector 1 is connected to the fan 3, the fan connector 1 outputs a pulse width modulation (PWM) signal received from the fan control chip 2 to the fan 3, to control a rotation speed of the fan 3. The fan connector 1 also outputs the rotation speed of the fan 3 to the fan control chip 2, to signal the fan control chip 2 to regulate the rotation speed of the fan 3.

In use, when the fan connector 1 is not connected to the fan 3, the detecting pin PRSNT_N of the fan control chip 2 receives a high level signal from the power source P3V3 through the resistor R1. The fan control chip 2 determines that the fan connector 1 is not connected to the fan 3. When the fan connector 1 is connected to the fan 3, because a detecting pin 31 of the fan 3 is grounded, thus, the detecting pin PRSNT of the fan connector 1 is grounded. A voltage at the detecting pin PRSNT_N of the fan control chip 2 is equal to the voltage drop Vp of the diode D1. In one embodiment, resistance of the resistor R1 is 4.7 kilohms (KΩ). Thus, a current flowing through the diode D1 is equal to 3.3V/4.7 KΩ=0.7 mA. According to a characteristic of the diode, the voltage drop Vp of the diode D1 is 0.32V. Namely, the voltage at the detecting pin PRSNT_N of the fan control chip 2 is equal to 0.32V. Because the low level signal received by the fan control chip 2 is less than 0.8V, the detecting pin PRSNT_N of the fan control chip 2 receives a low level signal. The fan control chip 2 determines that the fan connector 1 is connected to the fan 3.

While the fan 3 is being connected to or disconnected from the fan connector 1, an over-voltage will be generated and outputted to the diode D1. According to the connection relation of the diode D1, the diode D1 is turned off. Namely, the over-voltage is not outputted to the detecting pin PRSNT_N of the fan control chip 2, to avoid the fan control chip 2 being damaged. According to the characteristic of the diode, the smallest reverse breakdown voltage of the diode is 30V, thus, the over-voltage generated by the fan connector 1 can be prevented by the diode D1.

Even though numerous characteristics and advantages of the disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A protection circuit comprising:
a fan control chip comprising a first detecting pin;
a fan connector comprising a second detecting pin;
a first resistor; and
a diode comprising an anode and a cathode;
wherein the anode of the diode is connected to the first detecting pin of the fan control chip, the cathode of the diode is connected to the second detecting pin of the fan connector, the anode of the diode is also connected to a first power source through the first resistor.

2. The protection circuit of claim 1, wherein a resistance of the first resistor is 4.7 kilohms, a voltage outputted from the first power source is 3.3 volts.

3. The protection circuit of claim 1, further comprising second to fifth resistors, and a capacitor, wherein the fan control chip further comprises a first speed pin and a first signal pin, the fan connector further comprises a second speed pin, a second signal pin, a voltage pin, and ground pins; wherein a first end of the second resistor is connected to the first speed pin of the fan control chip, and a second end of the second resistor is connected to the second speed pin of the fan connector through the third resistor, a node between the second and third resistors is grounded through the fourth resistor, a first end of the fifth resistor is connected to the second speed pin of the fan connector, and a second end of the fifth resistor is connected to a second power source, the first signal pin of the fan control chip is connected to the second signal pin of the fan connector, the ground pins of the fan connector are grounded, the voltage pin of the fan connector is connected to the second power source, the capacitor is connected between the voltage pin of the fan connector and ground.
